(19) United States
(12) Patent Application Publication
(10) Pub. No.: US 2026/0250566 A1
(43) Pub. Date: Aug. 27, 2026

(54) SOLVENTLESS ADHESIVE COMPOSITIONS AND LAMINATE MATERIALS PREPARED WITH THE SAME

(71) Applicant: ARKEMA FRANCE, Puteaux (FR)

(72) Inventors: Chenyan Bai, Shanghai (CN); Jianliang Zhu, Shanghai (CN); Lei Ying, Shanghai (CN); Gaobing Chen, Shanghai (CN); Xinhong Wang, Shanghai (CN); Thorsten Schmidt, Richterswil (CH)

(21) Appl. No.: 18/577,375

(22) PCT Filed: Jul. 30, 2021
(86) PCT No.: PCT/CN2021/109569

§ 371 Date: Jan. 8, 2024

(51) Int. Cl. C09J 175/08; C08G 18/12; C08G 18/40; C08G 18/42; C08G 18/44; C08G 18/48; C09J 5/00

(52) U.S. Cl. CPC C09J 175/08; C08G 18/12; C08G 18/4018; C08G 18/4202; C08G 18/44; C08G 18/4812; C08G 18/4825; C08G 18/4829; C09J 5/00

(57) ABSTRACT

Disclosed is a solventless adhesive composition comprising (A) an isocyanate component obtained by the reaction of re actants comprising at least one monomeric C₂-C₁₆ isocyanate compound and at least one first polyol; and (B) a polyol component comprising a silane coupling agent and particularly selected polyol(s). The solventless adhesive composition can be used for the production of laminate materials, e.g. exterior roofing laminate material, which well meets the requirements of various compliance regulations and has superior performance properties such as bond strength, weathering resistance, yellowing resistance, cracking resistance, delamination resistance, and the like. A method for producing said laminate material and the resultant laminate material are also disclosed.

### FIELD OF THE INVENTION

The present disclosure relates to a unique solventless (SL) adhesive composition, a laminate material, such as exterior roofing material, produced by using the same, and a method for producing the laminate material. The laminate material comprising an adhesive layer derived from the solventless adhesive composition well meets the requirements of various industry standard regulations and exhibits superior performance properties such as bond strength, weathering resistance, yellowing resistance, cracking resistance, delamination resistance, and the like.

### BACKGROUND

Adhesive compositions are useful for a wide variety of applications. For instance, they can be used to bond substrates such as polyethylenes, polypropylenes, polyesters, polyamides, metals, papers, or cellophanes to form composite films or sheets, i.e., laminates. The use of adhesives in different laminating end-use applications is generally known. For example, adhesives can be used in the manufacture of film/film and film/foil laminates commercially used in the field of exterior roofing laminate material. The laminates comprising metal foil/layer are widely used due to their desirable properties such as good light shielding properties, gas/moisture barrier property, and the like. Nevertheless, the foil containing laminates prepared by using SL adhesive face two challengers: the first one is the difficulty in meeting the requirements of various industry standard regulations, such as regulations of the exterior roofing laminate material, and the second one is the difficulty in maintaining good mechanical properties, such as bond strength, and long term weathering resistance, such as yellowing resistance, cracking resistance, delamination resistance, and the like. Therefore, there is a long-standing need to develop a unique adhesive which can be used for the production of a laminate material exhibiting desirable the above stated performance properties evert after long duration exposure to harsh outdoor climate.

After persistent exploration, we have surprisingly developed a unique SL adhesive composition which can achieve the above stated targets.

### SUMMARY OF THE INVENTION

The present disclosure provides a unique SL adhesive composition, a laminate material, e.g. a laminate roofing material, prepared by using the SL adhesive composition, and a method for preparing the laminate material.

In a first aspect of the present disclosure, the present disclosure provides a solventless adhesive composition, comprising:
(A) an isocyanate component comprising a prepolymer which is the reaction product of reactants comprising: (a) at least one monomeric C₂-C₁₆ isocyanate compound comprising more than one isocyanate groups, and (b) at least one first polyol selected from the group consisting of a first polyester polyol, optionally a first polyether polyol, optionally a first polycarbonate polyol, and combinations thereof, wherein the prepolymer comprises more than one free isocyanate groups;
(B) a polyol component comprising a silane coupling agent and at least one second polyol selected from the Troup consisting of a second polyester polyol, a second polyether polyol, optionally a second polycarbonate polyol, and any combinations thereof.

In a second aspect of the present disclosure, the present disclosure provides a laminate material, e.g. a laminate exterior roofing material, comprising at least one first substrate, at least one second substrate, and at least one adhesive layer sandwiched therebetween, wherein the adhesive layer is derived from the solventless adhesive composition according to the present disclosure, and each of the first and second substrate is independently selected from the group consisting of metal foil, polymer layer, fabric layer, and combinations thereof.

In a third aspect of the present disclosure, the present disclosure provides a method of producing the laminate material of the present disclosure, comprising:
(a) providing at least one first substrate and at least one second substrate; and
b) adhering the first substrate and the second substrate together by using the solventless adhesive composition of the present disclosure.

It is to be understood that both the foregoing general description and the following detailed description are exemplary and explanatory only and are not restrictive of the invention, as claimed.

### BRIEF DESCRIPTION OF THE DRAWINGS

FIG. 1 is a schematic illustration of a cross-section of one embodiment of an exterior roofing laminate material described herein.

### DETAILED DESCRIPTION OF THE INVENTION

Unless defined otherwise, all technical and scientific terms used herein have the same meaning as commonly understood by one of ordinary skill in the art to which the invention belongs. Also, all publications, patent applications, patents, and other references mentioned herein are incorporated by reference.

As disclosed herein, “and/or” means “and, or as an alternative”. All ranges include endpoints unless otherwise indicated.

According to art embodiment of the present disclosure, the adhesive composition is a “two-part” or “two-package” composition comprising an isocyanate component (A) and a polyol component (B). According to another embodiment, the isocyanate component (A) and the polyol component (B) are packaged, transported and stored separately, combined shortly or immediately before being used for the manufacture of the laminate article.

Without being limited to any specific theory, the technical breakthrough of the present disclosure mainly resides in the particularly designed formulation of the adhesive composition. Especially, it is found that the polyurethane system prepared by using (A) a prepolymer derived from monomeric C₂-C₁₆ isocyanate compound, such as C₅-C₁₈ cycloaliphatic diisocyanate, polyester polyol, and optional poly ether/polycarbonate polyol, (B) a polyol component composed of silane coupling agent, polyester polyol, polyether polyol and optional polycarbonate polyol can be used as adhesive for a laminate material, such as a foil-adhesive-polymer multilayer exterior roofing laminate material, exhibiting desirable performance properties. It is also found that the categories and relative contents of the ingredients used for each of the above stated components can be further modified to achieve further improvements in the performance properties of the SE adhesive and the laminate material.

### The Isocyanate Component (A)

According to an embodiment of the present disclosure, the isocyanate component (A) has an average NCO functionality of at least about 1.5, or from about 1.6 to 10, or from about 1.7 to about 8, or from about 1.8 to about 6, or from about 1.9 to about 5, or front about 2 to about 4, or from about 2 to about 3, or from about 2 to 2.5, or within a numerical range obtained by combining any two of the above indicated end points. For example, the isocyanate component (A) has an average NCO functionality of 2.0.

According to an embodiment, the prepolymer contained in the isocyanate component (A) is a reaction product formed by the reaction of (a) at least one monomeric C₂-C₁₆ isocyanate compound comprising more than one isocyanate groups, and (b) at least one first polyol selected from the group consisting of a first polyester polyol, optionally a first polyether polyol, optionally a first polycarbonate polyol, and combinations thereof, wherein the prepolymer comprises more than one free isocyanate groups, such as at least two free isocyanate groups. For example, the prepolymer has an average NCO functionality of larger than 1.0, or at least 1.5, or at least about 2.0, or from about 2.0 to 10, or from about 2.0 to about 8, or from about 2.0 to about 6, or from about 2.0 to about 5, or from about 2 to about 4, or from about 2 to about 3, or from about 2 to 2.5, or has a NCO functionality of 2.0, or within a numerical range obtained by combining an two of the above indicated end points.

According to an embodiment of the present disclosure, the monomeric C₂-C₁₆ isocyanate compound used for preparing the prepolymer may include any monomeric C₇-C₁₆ isocyanate compound selected from the group consisting of C₂-C₁₂ aliphatic isocyanates comprising at least two isocyanate groups, C₅-C₁₈ cycloaliphatic comprising at least two isocyanate groups, CC aromatic diisocyanate comprising at least two isocyanate groups, carbodiimide modified isocyanate, allophanate modified isocyanate, and combinations thereof. According, to another embodiment of the present disclosure, the the monomeric C₂-C₁₆ isocyanate compound used for preparing the prepolymer may include C₆-C₁₆ cycloaliphatic comprising at least two isocyanate groups, such as various isomers of isophorone diisocyanate (IPDI), methylene-bis(cyclohexylisocyanate) (HMDI) and the mixture of IPDI and HDMI. According to an embodiment of the present disclosure, the isophorone diisocyanate comprises isophorone-1,4-diisocyanate, isophorone-1,2-diisocyanate and isophorone-1,3-diisocyanate. According to an embodiment of the present disclosure, the methylene-bis(cyclohexylisocyanate) comprises methylene-bis(4-cyclohexylisocyanate), methylene-bis(3-cyclohexylisocyanate) and methylene-bis(2-cyclohexylisocyanate). According to a preferable embodiment of the present disclosure, the isophorone diisocyanate has a molecular structure represented by Formula Ia, and the methylene-bis(cyclohexylisocyanate) has a molecular structure represented by Formula Ib.

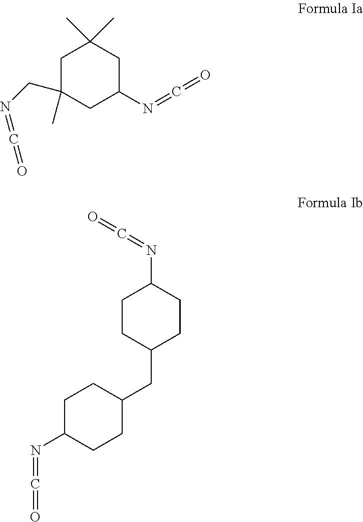 [SMILES: CC1(C)CC(N=C=O)CC(C)(CN=C=O)C1 ; O=C=NC1CCC(CC2CCC(N=C=O)CC2)CC1]

According to an embodiment of the present disclosure, the component (A) exclusively comprises IPDI and/or HMDI as isocyanate raw materials for preparing the prepolymer and does not comprise any isocyanate-functionalized compounds other that IPDI and HMDI. According to another embodiment of the present disclosure, the solventless adhesive composition does not comprise any isocyanate-functionalized compounds or precursor thereof other that IPDI and HMDI.

According to another embodiment of the present disclosure, the monomeric C₂-C₁₆ isocyanate compound used for preparing the prepolymer of component (A) can be a mixture of said IPDI and/or HMDI, and additional isocyanate compound(s) other than said IPDI and HMDI, wherein said “additional isocyanate compound” can be selected from the group consisting of C₂-C₁₂ aliphatic isocyanates comprising at least two isocyanate groups, C₆-C₁₅ cycloaliphatic comprising at least two isocyanate groups (other than IPDI and HMDI), C₆-C₁₈ aromatic diisocyanate, carbodiimide modified isocyanate, allophanate modified isocyanate, and combinations thereof. Exemplary additional isocyanate compounds can be selected from the group consisting of m-phenylene diisocyanate, 2,4-toluene diisocyanate and/or 2,6-toluene diisocyanate (TDI), the various isomers of diphenylmethanediisocyanate (MDI), carbodiimide modified MDI products, hexamethylene 1,6-diisocyanate, tetramethylene-1,4-diisocyanate, naphthylene-1,5-diisocyanate, isomers of naphthalene-dipolyisocyanate (“NDI”) such as 1, 5 NDI, isomers of hexamethylene dipolyisocyanate (“HDI”), isomers of xylene dipolyisocyanate (“XDI”), or mixtures thereof. The content of said additional isocyanate compound (other than IPDI and HMDI) can be from 1 wt % to 50 wt %, or from 2 wt % to 45 wt %, or from 5 wt % to 40 wt %, or from 8 wt % to 35 wt %, or from 10 wt % to 30 wt %, or from 12 wt % to 25 wt %, or from 15 wt % to 20 wt %, or ≤15 wt %, or ≤12 wt %, or ≤10 wt %, or ≤8 wt %, or ≤6 wt %, or ≤5 wt %, or ≤2 wt %, or ≤1 wt %, or 0 wt %, based on the total weight of all the isocyanate compounds.

According to another embodiment of the present disclosure, the monomeric C₂-C₁₆ isocyanate compound used for preparing the prepolymer of component (A) exclusively comprises the above stated “additional isocyanate compound” and does not comprise said IPDI and/or HMDI.

In an embodiment of the present disclosure, the content of the (a) monomeric C₂-C₁₆ isocyanate compound is from 40 to 60 wt %, based on the total weight of the isocyanate component (A), such as within a numerical range obtained by combining any two of the following end points: 40 wt %, 42 wt %, 45 wt %, 48 wt %, 50 wt %, 52 wt %, 55 wt %, 58 wt % and 60 wt %, based on the total weight of the isocyanate component (A).

Compounds having isocyanate groups, such as the above said prepolymer, monomeric C₂-C₁₆ isocyanate compound, IPDI/HMDI and the additional isocyanate compounds, may be characterized by the parameter “% NCO” which is the amount of isocyanate groups by weight based on the weight of the compound. The parameter % NCO can be measured by the method of ASTM D 2572-97 (2010). According to an embodiment of the present disclosure, the prepolymer and the monomeric C₂-C₁₆ isocyanate compound may have a % NCO of at least 3 wt %, or at least 5 wt %, or at least 7 wt %. In some embodiments, the prepolymer and the monomeric C₂-C₁₆ isocyanate compound have a % NCO not to exceed 40 wt %, 35 wt %, 30 wt %, or 25 wt %, or 22 wt %, or 20 wt %.

According to an embodiment of the present disclosure, the raw materials for preparing the prepolymer of component (A) do not comprise hexamethylene diisocyanate (HDI) or any isomers/dimer/trimer/oligomer thereof. According to another embodiment of the present disclosure, the raw materials for preparing the prepolymer of component (A) do not comprise xylylene diisocyanate (XLI) or any isomers/dimer/trimer/oligomer thereof.

According to an embodiment of the present disclosure, the first polyol used for preparing the prepolymer of component (A) can be selected from the group consisting of a first polyester polyol, optionally a first polyether polyol, optionally a first polycarbonate polyol, and combinations thereof.

According to an embodiment of the present disclosure, the first polyester polyol has a hydroxyl functionality of at least 1.8, at least 2.0, and up to 2.2, or up to 2.5, or up to 2.8, or up to 3.0, or within a numerical range obtained by combining any two of the above indicated end points. The first polyester polyol may have a molecular weight from 500 to 5,000 g/mol, or from 600 to 3,000 g/mol, or from 800 to 2,000 g/mol, or from 1,000 to 1,500 g/mol, or within a numerical range obtained by combining any two of the above indicated end points. The polyester polyol is typically obtained by reacting polyfunctional alcohols having from 2 to 12 carbon atoms, preferably from 2 to 10 carbon atoms, with polyfunctional carboxylic acids having from 2 to 12 carbon atoms, preferably 2 to 10 carbon atoms, or anhydrides/esters thereof. Typical polyfunctional alcohols for preparing the polyester polyol are preferably diols, triols, tetraols, and may include ethylene glycol, butylene glycol, diethylene glycol, triethylene glycol, polyalkylene glycols, 1,2-propanediol, 1,3-propanediol, 1,3-butanediol, 1,4-butanediol, 1,6-hexanediol, neopentyl glycol, trimethylolpropane, glycerol, erythritol, pentaerythritol, trimethylbenzene, and any combinations thereof. Typical polyfunctional carboxylic acids for preparing the first polyester polyol can be aliphatic, cycloaliphatic, araliphatic, aromatic or heterocyclic and may be substituted, for example with halogen atoms, and/or may be saturated or unsaturated. Preferably, the polyfunctional carboxylic acids are selected from the group consisting of adipic acid, suberic acid, azelaic acid, sebacic acid, phthalic acid, isophthalic acid, glutaric acid, tetrachlorophthalic acid, maleic acid, fumaric acid, itaconic acid, malonic acid, 2-methyl succinic acid, 3,3-diethyl glutaric acid, 2,2-dimethyl succinic acid, trimellitic acid, the anhydrides thereof, and any combinations thereof. Preference is given to adipic acid or a mixture of adipic acid and isophthalic acid. In another embodiment, the first polyester polyol has an OH number of 30 to 200 mg KOH/g, preferably from 40 to 180 mg KOH/g, and more preferably from 50 to 160 mg KOH/g. According to an embodiment of the present disclosure, the content of the first polyester polyol is from 50 wt % to 100 wt %, based on the total weight of the first polyol (h), such as within a numerical range obtained by combining any two of the following end points: 60 wt %, 62 wt %, 65 wt %, 68 wt %, 70 wt %, 72 wt %, 75 wt %, 78 wt %, 80 wt %, 82 wt %, 85 wt %, 88 wt %, 90 wt %, 92 wt %, 95 wt %, 98 wt % and 100 wt %, based on the total weight of the first polyol (b).

According to an embodiment of the present disclosure, the first polyether polyol has a hydroxyl functionality of 1.8 to 30, such as at least 1.8, or at least 2.0, or at least 2.2, or at least 2.5, or up to 2.6, or up to 2.7, or up to 2.8, or up to 2.9, or up to 3.0, or within a numerical range obtained by combining any two of the above indicated end points. The first polyether polyol may have a molecular weight from 400 to 5,000 g/mol, or from 500 to 4,000 g/mol, or from 600 to 3,000 g/mol, or from 800 to 2,000 g/mol, or from 1,000 to 1,500 g/mol, or within a numerical range obtained by combining any two of the above indicated end points. For example, the first polyether polyols can be prepared by polymerization of one or more alkylene oxides selected from ethylene oxide (EO), propylene oxide (PO), butylene oxide, tetrahydrofuran, trimethylolpropane, glycerol, erythritol, pentaerythritol, trimethylolbenzene, trishydroxyethyl isocyanurate, the condensation products of polyhydric alcohols, and any combinations thereof. Suitable examples of the first polyether polyols include polypropylene glycol (PPG), polyethylene glycol (PEG), polybutylene glycol, polytetramethylene ether glycol (PTMEG), and any combinations thereof. Alternatively, the polyether polyols can be the combinations or copolymers of PEG and at least one another polyether polyol as described above. For example, the polyether polyols can be the combinations of PEG and at least one of PPG, polybutylene glycol, and PTMEG. According to an embodiment of the present disclosure, the amount of the above stated first polyether polyols can be 0-20 wt %, or at most 18 wt %, or at most 15 wt %, or at most 12 wt %, or at most 10 wt % of the total weight of the first polyols.

According to an embodiment of the present disclosure, the first polycarbonate polyol has a hydroxyl functionality of at least 1.8, at least 2.0, or at least 2.1, or at least 2.2, or at least 2.3, or at least 2.4, or at least 2.5, or up to 2.6, or up to 2.7, or up to 2.8, or up to 2.9, or up to 3.0, or within a numerical range obtained by combining any two of the above indicated end points. The first polycarbonate polyol may have a molecular weight from 500 to 5,000 g/mol, or from 600 to 3,000 g/mol, or from 800 to 2,000 g/mol, or from 1,000 to 1,500 g/mol, or within a numerical range obtained by combining any two of the above indicated end points. For example, polycarbonate polyols may include those derived from butanediol, hexanediol, and cyclohexanedimethanol. In the above stated embodiments, the amount of the first polycarbonate polyol can be from 0 wt % to 28 wt %, such as 0 wt % to 25 wt %, or 1 wt % to 22 wt %, or 5 wt % to 20 wt %, or at most 18 wt %, or at most 16 wt %, or at most 15 wt %, or at most 10 wt %, or at most 5 wt %, or at most 2 wt %, or at most 1 wt %, or 0 wt % of the total weight of the first polyols, or within a numerical range obtained by combining any two of the above indicated end points.

In an embodiment of the present disclosure, and the content of the (b) first polyol is 40-60 wt %, based on the total weight of the isocyanate component (A), such as within a numerical range obtained by combining any two of the following end points: 40 wt %, 42 wt %, 45 wt %, 48 wt %, 50 wt %, 52 wt %, 55 wt %, 58 wt %, 60 wt %, based on the total weight of the isocyanate component (A).

In an embodiment of the present disclosure, the isocyanate component (A) may further comprise isocyanate-based silane coupling agent, such as 3-isocyanatepropyltriethoxysilane and 3-isocyanatepropyl trimethoxysilane, and the content of said isocyanate-based silane coupling agent can be from 0 wt % to 20 wt %, such as within a numerical range obtained by combining any two of the following end points: 0 wt %, 1 wt %, 2 wt %, 3 wt %, 4 wt %, 5 wt %, 6 wt %, 8 wt %, 10 wt %, 12 wt %, 14 wt %, 15 wt %, 17 wt %, 18 wt %, 19 wt % and 20 wt %, based on the total weight of the isocyanate component (A). The isocyanate-teased silane coupling agent may present in the isocyanate component (A) as a component independent from the prepolymer or can be added during the preparation of the prepolymer so as to be present as copolymerized units of the prepolymer.

According to another embodiment of the present disclosure, the isocyanate component (A) does not comprise isocyanate-teased silane coupling agent.

### The Polyol Component (B)

According to various embodiments of the present disclosure, the polyol component comprises a silane coupling agent and at least one second polyol selected from the group consisting of a second polyester polyol, a second polyether polyol, optionally a second polycarbonate polyol, and any combinations thereof.

According to an embodiment of the present disclosure, the silane coupling agent is selected from the group consisting of vinyl-based silane coupling agents, epoxy-based silane coupling agents, methacrylic-based silage coupling agents, amino-based silane coupling agents, allyl-based silane coupling agents, and any combinations thereof. Examples of the vinyl-based silane coupling agent include vinyltrimethoxysilane, vinyltriethoxysilane, vinyltris(2-methoxyethoxy)silane, and vinylmethyldimethoxysilane. Examples of the epoxy-based silane coupling agent include 2-(3,4-epoxycyclohexyl)ethyltrimethoxysilane, 3-glycidoxypropyl methyldimethoxysilane, 3-glycidoxypropyltrimethoxysilane, 3-glycidoxypropylmethyl diethoxy silane and 3-glycidoxypropyltriethoxysilane. Examples of the methacryl-based silane coupling agent include 3-methacryloxypropylmethyldimethoxysilane, 3-methacryloxy propyltrimethoxysilane, 3-methacryloxypropylmethyldiethoxysilane, 3-methacryloxypropyl triethoxysilane, and 3-acryloxypropyltrimethoxysilane and the like. Examples of the amino-based silane coupling agent include N-2-(aminoethyl)-3-aminopropylmethyldimethoxysilane, N-2-(aminoethyl)-3-aminopropyltrimethoxysilane, and 3-aminopropyltrimethoxysilane, 3-aminopropyltriethoxysilane, 3-triethoxysilyl-N-(1,3-dimethyl-butylidene)propylamine, N-phenyl-3-aminopropyltrimethoxysilane and the like. Examples of the allyl-based silane coupling agent include allyltrimethoxysilane.

According to an embodiment, the content of the silane coupling agent can be from 0 wt % to 10 wt %, such as within a numerical range obtained by combining any two of the following end points: 0 wt %, 1 wt %, 2 wt %, 3 wt %, 4 wt %, 5 wt %, 6 wt %, 8 wt % and 10 wt %, based on the total weight of the polyol component (B).

According to an embodiment of the present disclosure, the second polyester polyol has a hydroxyl functionality of at least 1.8, or at least 1.9, or at least 2.0, or at least 2.1, or at least 2.2, or up to 2.3, or up to 2.4, or up to 2.5, or up to 2.6, or up to 2.7, or up to 2.8, or up to 2.9, or up to 3.0, or within a numerical range obtained by combining any two of the above indicated end points. The second polyester polyol may have a molecular weight from 500 to 5,000 g/mol, or from 600 to 3,000 g/mol, or from 800 to 2,000 g/mol, or from 1,000 to 1,500 g/mol, or within a numerical range obtained by combining any two of the above indicated end points. The above introduction about the origin, preparation process, category, molecular structure and various parameters of first polyester polyol also apply to this second polyester polyol. According to an embodiment of the present disclosure, the content of the second polyester polyol is from 20 wt % to 80 wt %, based on the total weight of the polyol component (B), such as within a numerical range obtained by combining any two of the following end points: 20 wt %, 22 wt %, 25 wt %, 28 wt %, 30 wt %, 32 wt %, 35 wt %, 38 wt %, 40 wt %, 42 wt %, 45 wt %, 48 wt %, 50 wt %, 52 wt %, 55 wt %, 58 wt %, 60 wt %, 62 wt %, 65 wt %, 68 wt %, 70 wt %, 72 wt %, 75 wt %, 78 wt % and 80 wt %, based on the total weight of the polyol component (B).

According to an embodiment of the present disclosure, the second polyether polyol has a hydroxyl functionality of 1.8 to 3.0, such as at least 1.8, or at least 1.9, or at least 2.0, or at least 2.1, or at least 2.2, or at least 2.3, or up to 2.4, or up to 2.5, or up to 2.6, or up to 2.7, or up to 2.8, or up to 2.9, or up to 3.0, or within a numerical range obtained by combining any two of the above indicated end points. The second polyether polyol may have a molecular weight from 400 to 5,000 g/mol, or from 500 to 4,000 g/mol, or from 600 to 3,000 g/mol, or from 800 to 2,000 g/mol, or from 1,000 to 1,500 g/mol, or within a numerical range obtained by combining any two of the above indicated end points. The above introduction about the origin, preparation process, category, molecular structure and various parameters of first polyether polyol also apply to this second polyether polyol. According to art embodiment of the present disclosure, the amount of the above stated second polyether polyols can be 20-70 wt %, based on the total weight of the polyol component (B), such as within a numerical rage obtained by combining any two of the following end points: 20 wt %, 22 wt %, 25 wt %, 28 wt %, 30 wt %, 32 wt %, 35 wt %, 38 wt %, 40 wt %, 42 wt %, 45 wt %, 48 wt %, 50 wt %, 52 wt %, 55 wt %, 58 wt %, 60 wt %, 62 wt %, 65 wt, 68 wt % and 70 wt %, based on the total weight of the polyol component (B).

According to an embodiment of the present disclosure, the second polycarbonate polyol has a hydroxyl functionality of 1.8 to 3.0, such as at least 1.8, or at least 1.9, or at least 2.0, or at least 2.1, or at least 2.2, or at least 2.3, or up to 2.4, or up to 2.5, or up to 2.6, or up to 2.7, or up to 2.8, or up to 2.9, or up to 3.0, or within a numerical range obtained by combining any two of the above indicated end points. The second polycarbonate polyol may have a molecular weight from 500 to 5,000 g/mol, or from 600 to 4,000 g/mol, or from 700 to 3,000 g/mol, or from 800 to 2,000 g/mol, or from 1,000 to 1,500 g/mol, or within a numerical range obtained by combining any two of the above indicated end points. The above introduction about the origin, preparation process, category, molecular structure and various parameters of first polycarbonate polyol also apply to this second polycarbonate polyol. According to an embodiment of the present disclosure, the amount of the above stated second polycarbonate polyols can be 0-40 wt %, based on the total weight of the polyol component (B), such as within a numerical range obtained by combining any two of the following end points: 0 wt %, 1 wt %, 2 wt %, 4 wt %, 5 wt %, 6 wt %, 7 wt %, 8 wt %, 9 wt %, 10 wt %, 11 wt %, 12 wt %, 14 wt %, 15 wt %, 16 wt %, 17 wt %, 18 wt %, 19 wt %, 20 wt %, 22 wt %, 25 wt %, 28 wt %, 30 wt %, 32 wt %, 35 wt %, 38 wt %, 40 wt % and 40 wt %, based on the total weight of the polyol component (B).

According to one embodiment of the present disclosure, the (B) polyol component and/or the isocyanate component (A) may further comprises one or more polyol functionalized with free or encapped functional groups other than hydroxyl group, such as one or more of phosphorous-functionalized polyol, carboxyl group-functionalized polyol, thiol-functionalized polyol, and the like.

According to another embodiment of the present disclosure, the solventless adhesive composition is free of polyol functionalized with free or encapped functional groups other than hydroxyl group, such as being free of phosphorous-functionalized polyol, carboxyl group-functionalized polyol, thiol-functionalized polyol, and the like.

According to an embodiment of the present disclosure, the polyol component (B) exclusively comprises a mixture of the silane coupling agent, the second polyester polyol and the second polyether polyol, and does not comprise any other polyols. According to another embodiment of the present disclosure, the polyol component (B) exclusively comprises a mixture of the silane coupling agent, the second polyester polyol, the second polyether polyol and the second polycarbonate polyol, and does not comprise any other polyols. According to a less preferable embodiment of the present disclosure, the polyol component (B) may further comprise one or more additional and traditional polyols such as polyacrylic polyol, ethylene-vinyl acetate polyol, silicone polyol, and the like.

### The Application of the SL Adhesive Composition

According to various embodiments of the present disclosure, the two-component adhesive composition of the present disclosure may comprise one or more solvents or can be completely solventless. As disclosed herein, the terms “solvent free”, “solventless” or “non-solvent”, can be used interchangeably and shall be interpreted that the mixture of all the raw materials used for preparing the adhesive composition comprise less than 3% by weight, preferably less than 2% by weight, preferably less than 1% by weight, more preferably less than 0.5% by weight, more preferably less than 0.2% by weight, more preferably less than 0.1% by weight, more preferably less than 100 ppm by weight, more preferably less than 50 ppm by weight, more preferably less than 10 ppm by weight, more preferably less than 1 ppm by weight of any organic or inorganic solvents, based on the total weight of the mixture of raw materials. As disclosed herein, the term “solvent” refers to organic and inorganic liquids whose function is solely dissolving one or more solid, liquid or gaseous materials without incurring any chemical reaction.

According to various embodiments of the present disclosure, the weight ratio between the isocyanate component (A) and the poloyl component (B) can be 100:(30-110). When the total weight of the isocyanate component (A) is taken as 100 parts by weight, the amount of poloyl component (B) can be from 30 to 110 parts by weight, such as within a numerical range obtained by combining any two of the following end values: 30 parts by weight, 31 parts by weight, 32 parts by weight, 34 parts by weight, 35 parts by weight, 36 parts by weight, 38 parts by weight, 39 parts by weight, 40 parts by weight, 42 parts by weight, 44 parts by weight, 45 parts by weight, 46 parts by weight, 47 parts by weight, 48 parts by weight, 49 parts by weight, 50 parts by weight, 52 parts by weight, 53 parts by weight, 54 parts by weight, 55 parts by weight, 56 parts by weight, 57 parts by weight, 5$ parts by weight, 59 parts by weight, 60 parts by weight, 62 parts by weight, 63 parts by weight, 64 parts by weight, 65 parts by weight, 66 parts by weight, 67 parts by weight, 68 parts by weight, 69 parts by weight, 70 parts by weight, 72 parts by weight, 73 parts by weight, 74 parts by weight, 75 parts by weight, 76 parts by weight, 77 parts by weight, 78 parts by weight, 79 parts by weight, 80 parts by weight, 82 parts by weight, 83 parts by weight, 84 parts by weight, 85 parts by weight, 86 parts by weight, 87 parts by weight, 88 parts by weight, $9 parts by weight, 90 parts by weight, 91 parts by weight, 92 parts by weight, 94 parts by weight, 95 parts by weight, 96 parts by weight, 97 parts by weight, 98 parts by weight, 99 parts by weight, 100 parts by weight, 101 parts by weight, 102 parts by weight, 104 parts by weight, 105 parts by weight, 106 parts by weight, 107 parts by weight, 108 parts by weight, 109 parts by weight and 110 parts by weight.

As stated above, the isocyanate component (A) and the polyol component (B) are transported and stored separately, combined shortly or immediately before being applied during the manufacture of the laminate article. In some embodiments, both the isocyanate component and the polyol component are liquid at ambient temperature. When it is desired to use the adhesive composition, the isocyanate component and the polyol component are brought into contact with each other and mixed together. Once mixed, polymerization (curing) reaction occurs between the free isocyanate groups in the isocyanate component (A) and the hydroxyl groups in the polyol component (B) to form a polyurethane which exhibit the function of adhesive in the adhesive layer between the at least one first substrate and the at least one second substrate. The adhesive composition formed by bringing the components (A) and (B) into contact can be referred to as a “curable mixture”.

One or more catalysts may be optionally used to promote or accelerate the above stated polymerization reaction for preparing the prepolymer in the isocyanate component (A) and/or the polymerization between the prepolymer of (A) and the polyol component (B).

The catalyst may include any substance that can promote the reaction between the isocyanate group and the hydroxyl group. Without being limited to theory, the catalysts can include, for example, glycine salts; tertiary amines: tertiary phosphines, such as trialkylphosphines and dialkylbenzylphosphines; morpholine derivatives; piperazine derivatives; chelates of various metals, such as those which can be obtained from acetylacetone, benzoylacetone, trifluoroacetyl acetone, ethyl acetoacetate and the like with metals such as Be, Mg, Zn, Cd, Pd, Ti, Zr, Sn, As, Bi, Cr, Mo, Mn, Fe, Co and Ni; acidic metal salts of strong acids such as ferric chloride and stannic chloride; salts of organic acids with variety of metals, such as alkali metals, alkaline earth metals, Al, Sn, Pb, Mn, Co, Ni and Cu; organotin compounds, such as tin(II) salts of organic carboxylic acids, e.g., tin(II) diacetate, tin(II) dioctanoate, tin(II) diethylhexanoate, and tin(II) dilaurate, and dialkyltin(IV) salts of organic carboxylic acids, e.g., dibutyltin diacetate, dibutyltin dilaurate, dibutyltin maleate and dioctyltin diacetate; bismuth salts of organic carboxylic acids, e.g., bismuth octanoate; organometallic derivatives of trivalent and pentavalent As, Sb and Bi and metal carbonyls of iron and cobalt, or mixtures thereof.

In general, the content of the catalyst used herein is larger than zero and is at most 1.0 wt %, preferably at most 0.5 wt %, more preferably at most 0.05 wt %, based on the total weight of all the reactants.

The SL adhesive composition of the present disclosure may optionally comprise any additional auxiliary agents and/or additives for specific purposes.

In one embodiment of the present disclosure, one or more of the auxiliary agents and/or additives may be selected from the group consisting of other cocatalysts, surfactants, toughening agents, flow modifiers, diluents, stabilizers, plasticizers, catalyst do-activators, dispersing agents and mixtures thereof.

A method of producing a laminate article using said adhesive composition is also disclosed. In some embodiments, the adhesive composition, such as the adhesive composition discussed above, is in a liquid state. In some embodiments, the composition is a liquid at 25° C. Even if the composition is solid at 25° C., it is acceptable to heat the composition as necessary to convert it into a liquid state. A layer of the composition is applied to a surface of a substrate or a film. A “substrate/film” is any structure that is 5 mm or less, such as 1 mm or less, in one dimension and is 1 cm or more in both of the other two dimensions. A polymer film is a film that is made of a polymer or mixture of polymers. The composition of a polymer film is, typically, 80 percent by weight or more by weight one or more polymers. In some embodiments, the thickness of the layer of the curable mixture applied to the film is 1 μm to 50 μm.

In some embodiments, a surface of another substrate/film is brought into contact with the layer of the curable mixture to form art uncured laminate. The adhesive composition may be applied by conventional lamination machine, e.g. Labo-Combi 400 machine from Nordmeccanica. The curable mixture is then cured or allowed to cure. The uncured laminate may be subjected to pressure, for example by passing through nip rollers, which may or may not be heated. The uncured laminate may be heated to speed the cure reaction. Suitable substrates/films include woven and nonwoven natural or synthetic fabric, metal foil/sheet, polymers, metal-coated polymers and polymers filled with various fillers and/or strengthening agents. Films optionally have a surface on which an image is printed with ink, and the ink may be in contact with the adhesive composition. In some embodiments, the substrates/films are polymer films or metal-coated polymer films, and more preferably are the combination of one metal foil/sheet and one polymer film.

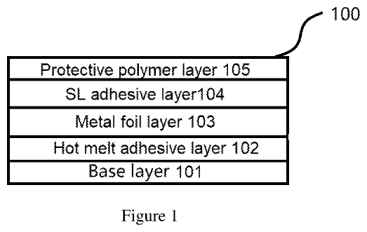

FIG. 1 shows the sectional view of a typical embodiment of the exterior roofing laminate material 100 comprising, from bottom to top, a base layer 101, a hot melt adhesive layer 102, a metal foil layer 103, a SL adhesive layer 104 and a protective polymer layer 105, wherein the SL adhesive layer 104 can be derived from the solventless adhesive composition of the present disclosure. The dimensions (e.g., thickness) of each layers are not drawn to the actual scale so as to clearly show the arrangement and structures. In the embodiment shown in FIG. 1, the above stated first substrate is a metal foil layer 103, and the second substrate is a protective polymer layer 105 which is adhered to the metal foil layer 103 by the SL adhesive layer 104. The exterior roofing laminate material 100 of FIG. 1 further comprises a base layer 101 which contributes additional mechanical strength and barrier function to the laminate material 100, and a hot melt adhesive layer 102 which adheres the base layer 101 to the other layers.

The embodiment shown in FIG. 1 is merely illustrative and many alternative embodiments may also be conceived. For example, the hot melt adhesive layer 102 and the base layer 101 may be omitted, and additional first/second substrates and SL adhesive layer may be arranged according to the target thickness and desired performance properties of the exterior roofing laminate material 100. Besides, the hot melt adhesive layer 102 and the base layer 101 can be replaced with the SL adhesive layer and the first/second substrate respectively.

The polymer which can be used for the first/second substrate can be selected from the group consisting of PE, HDPE, LDPE, PP, PVC, PET, PU, PV, PMA, PA, ABS, CA, EPDM, EVA, CPP, and any combinations or copolymers thereof.

The metal which can be used for the first/second substrate can be selected from the group consisting of Al, Al alloy, Fe, Steel, copper, copper alloy, Mg, Mg alloy, and any combinations or alloys thereof.

According to one embodiment of the present disclosure, each of the first substrate and the second substrate may have a thickness of from about 1 μm to 500 μm, such as within a numerical range obtained by using any two of the following values: 1 μm, 2 μm, 5 μm, 6 μm, 7 μm, 10 μm, 12 μm, 15 μm, 16 μm, 18 μm, 20 μm, 24 μm, 25 μm, 30 μm, 32 μm, 35 μm, 40 μm, 45 μm, 50 μm, 55 μm, 60 μm, 65 μm, 70 μm, 72 μm, 75 μm, 80 μm, 90 μm, 100 μm, 120 μm, 140 μm, 150 μm, 180 μm, 200 μm, 250 μm, 300 μm, 350 μm, 400 μm, 450 μm and 500 μm.

According to another embodiment of the present disclosure, the SL adhesive layer may have a thickness of from about 1 μm to 300 μm, such as within a numerical range obtained by using any two of the following values: 1 μm, 2 μm, 5 μm, 6 μm, 7 μm, 10 μm, 12 μm, 15 μm, 16 μm, 18 μm, 20 μm, 24 μm, 25 μm, 30 μm, 32 μm, 35 μm, 40 μm, 45 μm, 50 μm, 55 μm, 60 μm, 65 μm, 70 μm, 72 μm, 75 μm, 80 μm, 90 μm, 100 μm, 120 μm, 140 μm, 150 μm, 180 μm, 200 μm, 250 μm and 300 μm.

According to one embodiment of the present disclosure, each of the other layer, such as the base layer and the hot melt adhesive layer, may have a thickness of from about 1 μm to 500 μm, such as within a numerical range obtained by using any two of the following values: 1 μm, 2 μm, 5 μm, 6 μm, 7 μm, 10 μm, 12 μm, 15 μm, 16 μm, 18 μm, 20 μm, 24 μm, 2.5 μm, 30 μm, 32 μm, 35 μm, 40 μm, 45 μm, 50 μm, 55 μm, 60 μm, 65 μm, 70 μm, 72 μm, 75 μm, 80 μm, 90 μm, 100 μm, 120 m, 140 μm, 150 μm, 180 μm, 200 μm, 250 μm, 300 μm, 350 μm, 400 μm, 450 μm and 500 μm.

Another embodiment of the present disclosure relates to a process for preparing the exterior roofing laminate material 100 of FIG. 1, comprising the steps of (i) adhering the protective polymer layer 105 (e.g. a PET layer) to the metal foil layer 103 (e.g, an Al foil) by using a SL adhesive layer 104 to form a laminate; (ii) pasting the laminate obtained in step (i) to the base laser 101 (e.g. a panel of steel or aluminum) by using the polymeric hot melt adhesive to form an intermediate laminate; and (iii) subjecting the intermediate laminate to embossing and shaping treatment to produce the final exterior roofing laminate material 100. The materials for the hot melt adhesive and the base layer as well as the above stated embossing and shaping treatment are generally known to those skilled in the art.

The process of the present disclosure may be carried out continuously or batchwise. An example of the continuous process is a roll to roll process, in which a roll of a substrate/film is unwound and transmitted through two or more work station where the isocyanate component (A) and the polyol component (B) are mixed to form the adhesive composition (curable mixture) of the present application which is applied onto a surface of the substrate/film. The adhesive composition (curable mixture) of the present application can be applied more than once to achieve a desirable fill thickness or composition profile. A layer of foil/sheet may be applied onto the curable adhesive layer with or without the aid of rollers. Heating or irradiation devices may be arranged to promote the curing of the coated adhesive layer, and rollers can also be used for enhancing the adhesion strength within the laminate. The foil/sheet layer can also be unwound from a roll. The unwound substrates/film and foil/sheet can be from 10 to 20,000 meters, from 10 to 15,000 meters and preferably from 20 to 10,000 meters in length and are typically transmitted at a speed in the range from 0.1 to 60 m/min, preferably from 3 to 45 m/min, more preferable from 5 to 15 m/min. In the end of the continuous technology, the cured laminate product is wound up on a spindle.

The laminate material disclosed herein can be cut or otherwise shaped so as to have a shape suitable for any desired purpose, such as exterior roofing material.

### Examples

Some embodiments of the invention will now be described in the following Examples, wherein all parts and percentages are by weight unless otherwise specified. However, the scope of the present disclosure is not, of course, limited to the formulations set forth in these examples. Rather, the Examples are merely inventive of the disclosure.

The information of the raw materials used in the examples is listed in the following table 1:

TABLE 1
Raw materials used in the examples

| Brand name | Characterization | Vendor |
|---|---|---|
| Bester 648 | Polyester polyol having a OH functionality of 2 | Dow Chemical Company |
| Bester 115 | Polyester polyol having a OH functionality of 2 | Dow Chemical Company |
| Voranol CP450 | Polyether polyol having a OH functionality of 3 | Dow Chemical Company |
| XCPA-195 | Polyester polyol having a OH functionality of 2 | Xuchuan Chemical |
| 1500NH | Polyester polyol having a OH functionality of 2 | Xuchuan Chemical |
| UP-100 | Polycarbonate polyol baving a OH functionality of 2 | UBG |
| MF C411 | Solventless polyol coreactant comprising a blend of | Dow Chemical Company |
| | Polyester polyol and Polyether polyol | |
| Intermediate 88-102 | Polyester polyol coreactant | Dow Chemical Company |
| A-187 | Silane coupling agent | Momentive Performance Materials Inc. |
| Desmodur W (HMDI) | 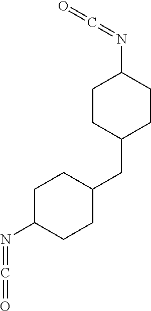 [SMILES: O=C=NC1CCC(CC2CCC(N=C=O)CC2)CC1] | Convestro co.ltd |
| IPDI | 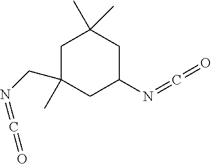 [SMILES: CC1(C)CC(N=C=O)CC(C)(CN=C=O)C1] | Convestro co.ltd |
| MF200C | Trimer of HDI | Dow Chemical Company |

### Preparation Examples of the Isocyanate Component A

Isocyanate Components (urethane prepolymer) of Inventive Preparation Examples (IPEx.) A1 to A4 and Comparative Preparation Example (CPEx) A were synthesized according to the procedure described below using the relative contents of raw materials listed in Table 2, in percentage by weight based on total weight of the isocyanate component.

The isocyanate Components (urethane prepolymers) are synthesized in a 1 L glass reactor. In particular, the diisocyanate monomers as shown in Table 2 were introduced into the reactor and maintained at 60° C. with nitrogen protection. Then the polyester glycol and additional polyols (such as polyether glycol and polycarbonate polyol, if any) shown in Table 2 were introduced into the reactor. The temperature of the reactor was slowly increased to 80-90° C. and maintained at this temperature until the theoretical end point of the reaction was achieved. The isocyanate component thus produced (i.e. the urethane prepolymer) was charged into a sealed container with nitrogen protection for further application.

TABLE 2
Formulations of the component A

| | IPEx. | IPEx. | IPEx. | IPEx. | CPEx. |
|---|---|---|---|---|---|
| | A1 | A2 | A3 | A4 | A |
| HMDI | 55 | | 55 | 55 | |
| IPDI | | 52 | | | |
| MF200C | | | | | 100 |
| Bester 648 | 32 | | | 35 | |
| Bester 115 | | 29.4 | | 10 | |
| Voranol CP450 | 3 | 4.5 | | | |
| 1500NH | | | 5 | | |
| XCPA-195 | | 4.5 | 40 | | |
| UP-100 | 10 | 9.6 | | | |
| Total | 100 | 100 | 100 | 100 | 100 |

### Preparation Examples of the Polyol Component B

Polyol Components of Inventive Preparation Examples (IPEx.) B1 to B4 and Comparative Preparation Example (CPEx.) B were synthesized by throughly blending the raw materials listed in Table 3 according to their specific amounts under ambient temperature, in percentage by weight based on total weight of the polyol component.

TABLE 3
The Formulation of component B

| | IPEx. B1 | IPEx. B2 | IPEx. B3 | IPEx. B4 | CPEx. B |
|---|---|---|---|---|---|
| XCPA-195 | | | 42 | | |
| UP-100 | 10 | | 23 | | |
| Bester 115 | | | | 58 | |
| Voranol | | | 30 | 40 | |
| CP450 | | | | | |
| MF C411 | 87 | 98 | | | |
| Intermediate | | | | | 95 |
| 88-102 | | | | | |
| A-187 | 3 | 2 | 5 | 2 | 5 |
| Total | 100 | 100 | 100 | 100 | 100 |

### Examples 1-4 and Comparative Example 1

According to the following Table 4, the adhesive compositions of Examples 1 to 4 and Comparative Example 1 were synthesized by using the Isocyanate components and polyol components prepared in the above indicated preparation examples. Laminates were prepared by using these adhesives in a Labo-Combi 400 machine from Nordmeccanica under the following processing conditions: line speed was set as 120 mpm and 150 mpm, temperature of transfer roller was 45° C., nip temperature was set as 60° C., and coating weight was set as 1.8 gsm. Different substrates were selected to form PET/A1, wherein the PET substrate has a thickness of 12 μm, and the Al foil has a thickness of 7 μm.

TABLE 4
The formulations of Examples 1-4 and Comparative Example 1

| | Formulation | Molar ratio |
|---|---|---|
| Example 1 | IPEx. A1/IPEx. B1 | 100:40 |
| Example 2 | IPEx. A2/IPEx. B2 | 100:40 |
| Example 3 | IPEx. A3/IPEx. B3 | 100:45 |
| Example 4 | IPEx. A4/IPEx. B4 | 100:50 |
| Comparative Example 1 | CPEx. A/CPEx. B | 30:100 |

The bond strength (BS) and heat seal strength (HS) of these laminates were characterized by using the following technologies.

### Test Technologies

### Bond Strength (BS)

Laminates prepared with the adhesive compositions were cut into 15 mm width strips for T-peel test under 250 mm/min crosshead speed using a 5940 Series Single Column Table Top System available from Instron Corporation. During the test, the tail of each strip was pulled slightly by fingers to make sure the tail remained 90 degree to the peeling direction. Three strips for each sample were tested and the average value was calculated. Results were represented with the unit of N/15 mm. A higher value represents a better the bond strength.

### Aging Experiment at a Temperature of 85° C. And a Humidity of 85%

The laminate samples prepared above were transferred into an oven set at a temperature of 85° C. and a humidity of 85%, and were continuously aged under such conditions for 14 days. Subsequently the aged samples were taken out, cooled down and subjected to the bond strength (BS) test.

### QUV Aging Experiment

The L, a, b and YIE313 of intact laminate samples prepared above were characterized with a ColorQuest XE colorimeter from Hunterlab, and then the laminate samples were put into a QUV (Q-panel Laboratory UltraViolet testing) machine and aged with 340 nm UV-irradiation under the temperature of 65° C. and the humidity of 50% for 14 days. Then the L, a, b and YIE313 of the aged laminate samples were further characterized with the above said colorimeter. The yellowing index of each sample was calculated based on the change in the above stated color parameters. A lower yellowing index value represents a less yellowing level.

The Bond Strength before and after the aging, and the yellowing index properties were summarized in Table 5, from which it can be seen that all the inventive examples exhibit superior BS which will not be deteriorated to an unacceptable extent even after a long term aging treatment, while the comparative example exhibits much higher deterioration in the BS after the aging treatment. Beside, all the inventive examples exhibit superior yellowing resistance.

TABLE 5
Characterization Results of Examples 1-4 and Comparative Example 1

| | PET/A1 BS | PET/A1 BS after aging | Yellowing index after QUV aging |
|---|---|---|---|
| Example 1 | 2.6 | 2.4 | 0.81(no obvious yellowing) |
| Example 2 | 2.7 | 2.3 | 1.21(no obvious yellowing) |
| Example 3 | 3.8 | 3.0 | 1.19(no obvious yellowing) |
| Example 4 | 3.0 | 2.4 | 1.09(no obvious yellowing) |
| Comparative Example 1 | 2.2 | 1.2 | 1.12 (no obvious yellowing) |

1. A solventless adhesive composition, comprising:
(A) an isocyanate component comprising a prepolymer which is the reaction product of reactants comprising: (a) at least one monomeric C₂-C₁₆ isocyanate compound comprising at more than one isocyanate groups, and (b) at least one first polyol selected from the group consisting of a first polyester polyol, optionally a first polyether polyol, optionally a first polycarbonate polyol, and combinations thereof, wherein the prepolymer comprises more than one free isocyanate groups;
(B) a polyol component comprising a silane coupling agent and at least one second polyol selected from the group consisting of a second polyester polyol, a second polyether polyol, optionally a second polycarbonate polyol, and any combinations thereof.

2. The solventless adhesive composition of claim 1, wherein the monomeric C₂-C₁₆ isocyanate compound is selected from the group consisting of C₂-C₁₆ aliphatic diisocyanate, C₅-C₁₈ cycloaliphatic diisocyanate, C₆-C₁₈ aromatic diisocyanate, carbodiimide modified isocyanate, allophanate modified isocyanate, and any combinations thereof.

3. The solventless adhesive composition of claim 1, wherein the monomeric cycloaliphatic isocyanate compound is selected from the group consisting of isophorone diisocyanate (IPDI), methylene-bis(cyclohexylisocyanate) (HMDI), and a combination thereof.

4. The solventless adhesive composition of claim 1, wherein the silane coupling agent is selected from the group consisting of epoxy-based silane coupling agent, vinyl-based silane coupling agent, methacrylic-based silane coupling agent, amino-based silane coupling agent, allyl-based silane coupling agent, and any combinations thereof; and
the isocyanate component optionally further comprises isocyanate-based silane coupling agent.

5. The solventless adhesive composition of claim 1, wherein the content of the (a) monomeric C₂-C₁₆ isocyanate compound is from 40 to 60 wt %, and the content of the (b) first polyol is 60-40 wt %, based on the total weight of the isocyanate component;
the first polyol comprises from 60 wt % to 100 wt % of the first polyester polyol, from 0 wt % to 20 wt % of the first polyether polyol and from 0 wt % to 28 wt % of the first polycarbonate polyol, based on the total weight of the first polyol; and
the (B) polyol component comprises from 0 to 10 wt % of the silane coupling agent, from 20 to 80 wt % of the second polyester polyol, from 20 to 70 wt % of the second polyether polyol and from 0 to 40 wt % of the second polycarbonate polyol, based on the total weight of the (B) polyol component.

6. The solventless adhesive composition of claim 1, wherein the weight ratio of the isocyanate component (A):the polyol component (B) is 100:(30-110).

7. The solventless adhesive composition of claim 1, wherein
the first polyester polyol has an average functionality of 1.8 to 3 and a molecular weight from 500 to 5,000;
the first polyether polyol has an average functionality of 1.8 to 3 and a molecular weight from 400 to 5,000;
the first polycarbonate polyol has an average functionality of 1.8 to 3 and a molecular weight from 500 to 5,000;
the second polyester polyol has an average functionality of 1.8 to 3 and a molecular weight from 500 to 5,000;
the second polyether polyol has an average functionality of 1.8 to 3 and a molecular weight from 400 to 5,000; and
the second polycarbonate polyol has an average functionality of 1.8 to 3 and a molecular weight from 500 to 5,000.

8. The solventless adhesive composition of claim 1, wherein the (A) isocyanate component optionally further comprises (c) at least one secondary isocyanate compound other than said (a) monomeric C₂-C₁₆ isocyanate compound, selected from the group consisting of C₂-C₁₆ aliphatic diisocyanate, C₅-C₁₈ cycloaliphatic diisocyanate, C₆-C₁₈ aromatic diisocyanate, carbodiimide modified isocyanate, allophanate modified isocyanate, or a combination thereof; and/or
the solventless adhesive composition is free of any polymerization unit derived from (meth)acrylate, (meth)acrylic acid, polylactone, polyolefin, bis-phenol resin and vinyl acetate.

9. A laminate material, comprising at least one first substrate, at least one second substrate, and at least one adhesive layer sandwiched therebetween, wherein the adhesive layer is derived from the solventless adhesive composition according to claim 1, and each of the first and second substrate is independently selected from the group consisting of metal foil, polymer layer, fabric layer, and combinations thereof.

10. A method of producing a laminate material, comprising:
(a) providing at least one first substrate and at least one second substrate; and
(b) adhering the first substrate and the second substrate together by using the solventless adhesive composition according to claim 1.
